(19) United States
(12) Patent Application Publication
(10) Pub. No.: US 2017/0330536 A1
(43) Pub. Date: Nov. 16, 2017

(54) PORTABLE STAND FOR A WIND MUSICAL INSTRUMENT AND METHOD

(71) Applicant: Amy Collins, Tarpon Springs, FL (US)

(72) Inventor: Amy Collins, Tarpon Springs, FL (US)

(21) Appl. No.: 15/595,789

(22) Filed: May 15, 2017

Related U.S. Application Data
(60) Provisional application No. 62/336,461, filed on May 13, 2016.

(51) Int. Cl. G10G 5/00; A45C 13/26; A45C 13/00; A45C 9/00; A45C 13/10; A45C 13/02; G10G 7/00; F16M 11/22

(52) U.S. Cl. CPC G10G 5/00; G10G 7/005; A45C 13/26; F16M 11/22; A45C 9/00; A45C 13/1069; A45C 13/02; A45C 13/005; F16M 2200/08

(57) ABSTRACT

A portable stand for a wind musical instrument including an instrument peg, a first-stand-section, and a second-stand-section. The instrument peg includes an instrument interface and a stand interface, with the instrument interface configured to removably interface with, and support the wind musical instrument. The instrument peg includes a first-inside face, a first-outside-face, and a first-perimeter extending, with the first-perimeter extending between the first-inside-face and the first-outside-face. The second-stand-section includes a second-inside-face, a second-outside-face, and a second-perimeter extending between the second-inside face and the second-outside-face, with the second inside-face including a second-recess dimensioned and sized to receive the complementary portion of the instrument peg. The second-stand-section is hingeably coupled to the first-stand-section by at least one hinge.

### CROSS-REFERENCE TO RELATED APPLICATION(S)

The present application is related to and claims priority to U.S. Provisional Patent Application Number 62/336,461 filed May 13, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of music of existing art and more specifically relates to instrument supports.

### RELATED ART

Instrument stands are typically bulky, awkward, and/or cumbersome, and the associated peg screws can easily break or bend if the instrument stand is transported assembled. Broken instrument pegs can render the instrument stand unusable. Having to constantly replace damaged instrument pegs can be frustrating, time consuming, and expensive. Further, if pegs are removed and transported separately, there is a chance the pegs could be lost. A suitable solution is desired.

U.S. Pat. Pub. No. 2003/0221538 to Robert Stevens relates to a musical instrument stand. The described musical instrument stand includes an easily disassembled, rugged stand for supporting musical instruments which does not require many moving parts such as hinges or screws. The stand is made of two similar interlocking supports, a cap and a removable, flexible strap. The supports are adapted to be fastened together and contain the cap when the stand is disassembled. Further, the flexible strap may be fastened to the supports and used as a handle. When the stand is assembled, the supports are further stabilized by the cap, and the flexible strap may be attached to the cap and used to hold, for example the neck of a guitar.

### SUMMARY OF THE INVENTION

In view of the foregoing disadvantages inherent in the known instruments supports art, the present disclosure provides a novel portable stand for a wind musical instrument. The general purpose of the present disclosure, which will be described subsequently in greater detail, is to provide a portable stand for a wind musical instrument and method.

A portable stand for a wind musical instrument is disclosed herein. The portable stand preferably includes an instrument peg, a first-stand-section, and a second-stand-section. The instrument peg includes an instrument interface and a stand interface, with the instrument interface configured to removably interface with, and therefore support one or more wind musical instruments.

The instrument peg includes a first-inside-face, a first-outside-face, and a first-perimeter, with the first-perimeter extending between the first-inside-face and the first-outside-face. The first-inside-face includes a first-recess, with the first-recess dimensioned and sized to receive a first portion of the instrument peg.

The second-stand-section includes a second-inside-face, a second-outside-face, and a second-perimeter extending between the second-inside face and the second-outside-face, with the second-inside-face including a second-recess dimensioned and sized to receive the complementary portion of the instrument peg. The second-stand-section is hingeably coupled to the first-stand-section by at least one hinge. An instrument peg mount is secured to at least one of the first-stand-section and the second-stand-section, with the instrument peg mount configured removably receive and support the instrument peg by use of the stand interface.

A carrying handle and security lock are also included in the preferred embodiment, with the carrying handle configured to support the portable stand while in a secured state and the security lock configured to maintain the portable stand in the secured state. As such the portable stand is openable such that the portable stand may be used in a deployed state and transported in a secured state.

The deployed state is defined by the first-stand-section and the second-stand-section being open relative to the hinge(s), by the stand interface of the instrument peg being received and coupled to the instrument peg mount such that the instrument peg is supported in an upright orientation, and by the first-stand-section and the second-stand-section arranged as a base for the instrument peg to support the wind musical instrument in the upright orientation.

The secured state is defined by the first-stand-section and the second-stand-section being closed relative to the hinge(s), by the first-inside face of the first-stand-section mating with the second-inside face of the second-stand-section, and by the first portion and the complementary portion of the instrument peg being received by and placed into the first inside-face of the first-stand-section and the second inside-face of the second-stand-section, respectively.

According to another embodiment, a method of using a portable stand for a wind musical instrument is also disclosed herein. The method of using a portable stand for a wind musical instrument includes a first step of providing a portable stand, a second step of a opening the portable stand into an open position, a third step of placing an instrument peg into a first-stand-section and/or a second-stand-section, a fourth step of placing at least one musical instrument upon the instrument peg, a fifth step of removing the musical instrument from the instrument peg, a sixth step of removing the instrument peg, and a seventh step of placing the instrument peg into the first-half-section or the second-half-section.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable stand for a wind musical instrument, constructed and operative according to the teachings of the present disclosure.

FIG. 1 is a perspective view of the portable stand for a wind musical instrument during an ‘in-use’ condition, according to an embodiment of the disclosure.

FIG. 2 is a perspective view of the portable stand for a wind musical instrument of

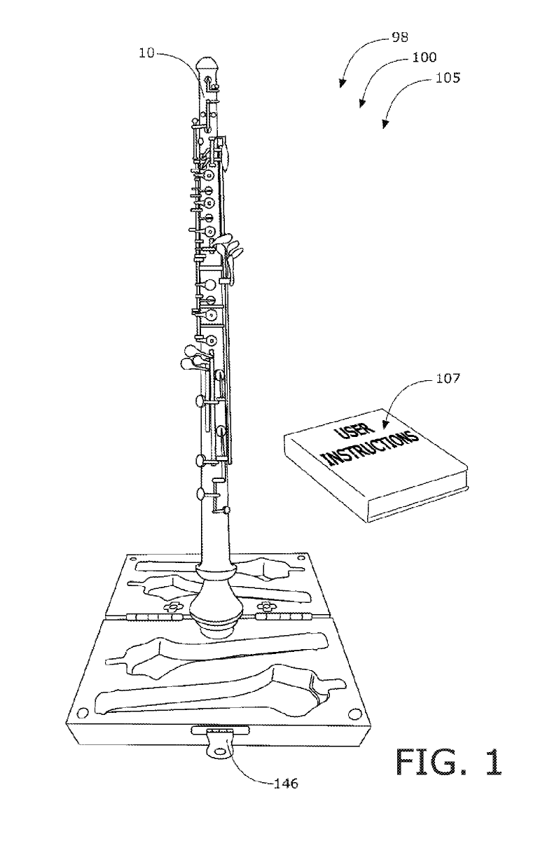

FIG. 1 in a deployed state, according to an embodiment of the present disclosure.

FIG. 3 is a perspective view of the portable stand for a wind musical instrument of FIG. 1 in a deployed state, according to an embodiment of the present disclosure.

FIG. 4 is a perspective view of the portable stand for a wind musical instrument of FIG. 1 in a secured state, according to an embodiment of the present disclosure.

FIG. 5 is a flow diagram illustrating a method of using a portable stand for a wind musical instrument, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an instrument supports and more particularly to a portable stand for a wind musical instrument as used to improve the durability and portability of a stand for musical instruments in a device convenient for carrying by a user.

Generally, a portable stand for a wind musical instrument is a base stand for wind instruments such as oboes, clarinets, piccolos, English horns, and other wind instruments. The device is intended to easily transport an instrument stand and its pegs. The device is comprised of a rectangular case with interior indentations sized for receiving an instrument and instrument pegs. The device is comprised of a rectangular case (which becomes the base when opened and the interior indentations sized for the instrument pegs which are then screwed into the base in the holes provided). The pegs are removed from inside the box and screwed into the holes. The device can be easily modified for an oboe, English horn, flute, piccolo, Bb and A clarinets, and other wind instruments. The device prevents damage to instrument pegs during transportation

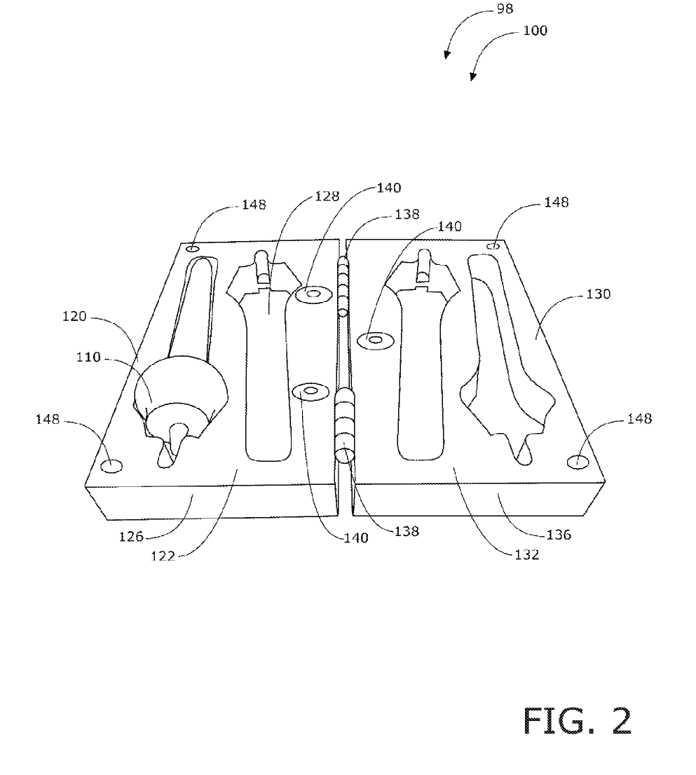

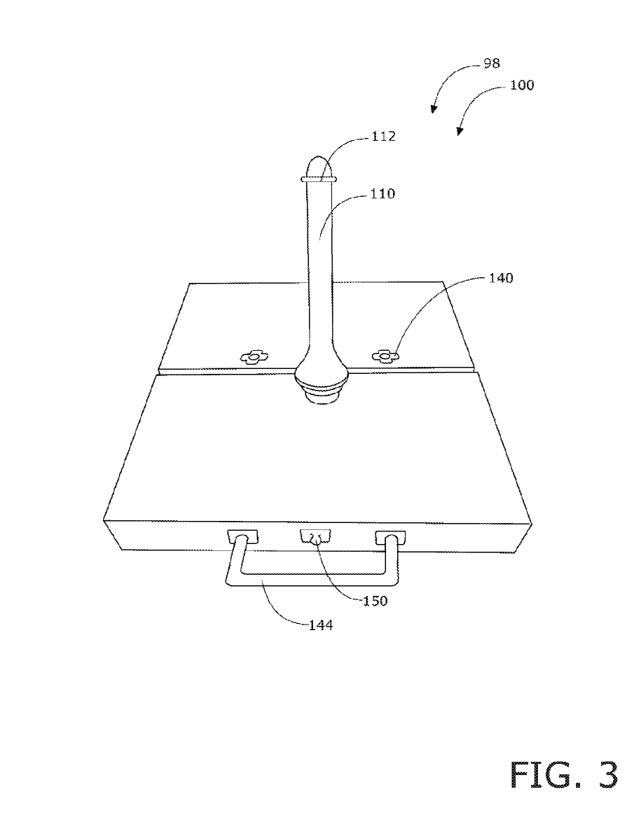

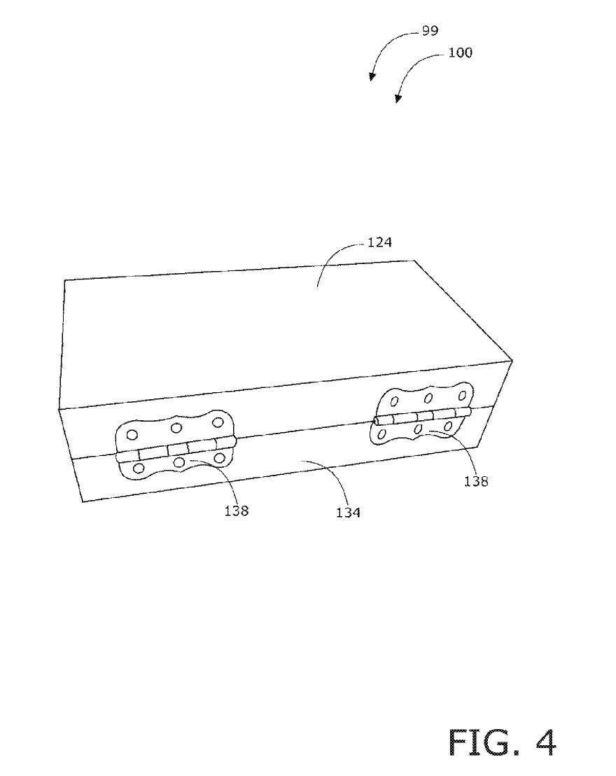

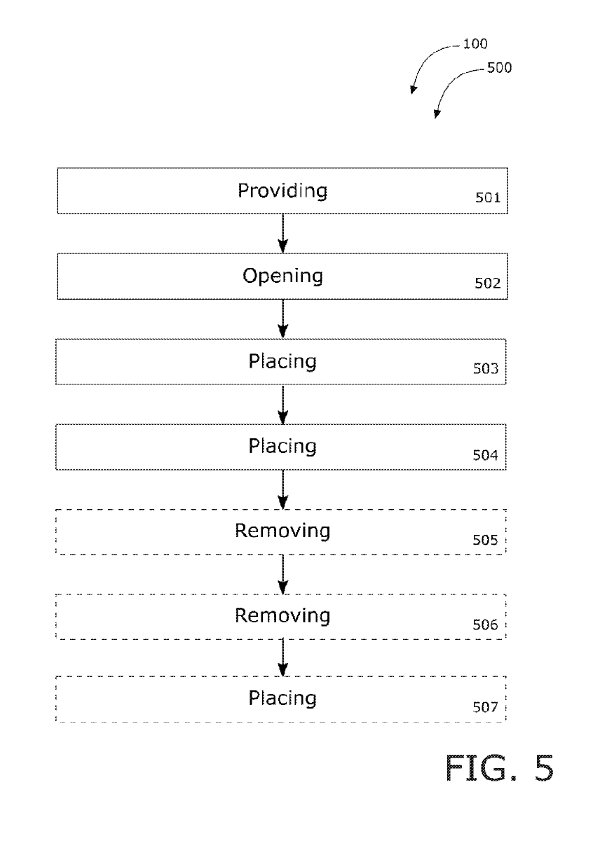

A portable stand for a wind musical instrument can be constructed using wood and/or other suitable materials. The device may be available in different sizes in order to accommodate different types of instruments. Exact size, measurement, construction, and design specifications may vary upon manufacturing. Referring now more specifically to the drawings by numerals of reference, there is shown in FIGS. 1-4, various views of a portable stand for a wind musical instrument 100.

FIGS. 1-4 show a portable stand for a wind musical instrument 100 during an ‘in-use’ condition 50, according to an embodiment of the present disclosure. Here, portable stand for a wind musical instrument 100 may be beneficial for use by a user to provide a device that is readily transportable while reducing damage to the portable stand for a wind musical instrument 10 during transport. As illustrated, the portable stand for a wind musical instrument 100 may include instrument peg 110, first-stand-section 120, and second-stand-section 130, where the portable stand 100 has a deployed state 98 and a secured state 99.

Deployed state 98 may be defined by first-stand-section 120 and second-stand-section 130 being opened relative to at least one hinge 138, by stand interface 114 of instrument peg 110 being received and coupled to instrument peg mount 140 such that instrument peg 110 may be supported in an upright orientation (other embodiments may include angles of inclination), and by first-stand-section 120 and the second-stand-section 130 arranged as a base for instrument peg 110 to support wind musical instrument 10 in an upright (or slightly inclinated) orientation.

Secured state 99 may be defined by first-stand-section 120 and second-stand-section 130 being closed relative to at least one hinge 138, by first-inside-face 122 of first-stand-section 120 mating with second-inside-face 132 of second-stand-section 130, and by the first portion and the complementary portion of instrument peg 110 being received by and embedded in the closed first-inside-face 122 of the first-stand-section 120 and the second-inside-face 132 of the second-stand-section 120, respectively. Portable stand 100 may be configured to receive, support, and stow a plurality of instrument pegs 110. Portable stand 100 may also comprise security lock 146 configured to maintain portable stand 100 in secured state 99.

According to one embodiment, portable stand for a wind musical instrument 100 may be arranged as a kit 105. In particular, portable stand for a wind musical instrument 100 may further include a set of instructions 107. Instructions 107 may detail functional relationships in relation to the structure of the portable stand for a wind musical instrument 100 such that portable stand for a wind musical instrument 100 can be used, maintained, or the like, in a preferred manner.

In some embodiments at least portions of first-inside face 122 and first-outside-face 124 may include a padding configured to provide protection to instrument peg 110 during transport and use. Also, at least one hinge 138 may include two hinges in some embodiments. Other embodiments may include a single hinge 138 (e.g., piano-hinge, etc.) to provide additional strength and durability.

In some embodiments, instrument peg mount 140 may include a threaded receiver; and stand interface 114 of instrument peg 110 may be configured to screw into the threaded receiver of instrument peg mount 140. Also, a second (or more) instrument peg(s) may include a second (or correspondingly more) instrument interface(s) and a second stand interface, with second instrument interface configured removably interface with and support a second wind musical instrument. Portable stand 100 may also include a second instrument peg mount secured to at least one of the first-stand-section and the second-stand-section, the second instrument peg mount configured removably receive and support the second instrument peg via the second stand interface. Additionally, first-inside face 122 of first-stand-section 120 may further include a second-recess dimensioned and sized to receive a second portion of the second instrument peg; wherein the second-inside face of the second-stand-section may further include a fourth-recess dimensioned and sized to receive a second complementary portion of a second instrument peg.

As such, when in deployed state 98 may be defined by the second stand interface of the second instrument peg being received and coupled to the second instrument peg mount such that the second instrument peg is supported in a second upright orientation, and by the first-stand-section 120 and the second-stand-section 130 being further arranged as the base for the second instrument peg to support the second wind musical instrument in the second upright orientation.

Also, secured state 99 is further defined by the second portion and the second complementary portion of the instrument peg being received by and embedded in the closed first inside-face of the first-stand-section and the second inside-face of the second-stand-section, respectively.

Embodiments may include first-stand-section 120, and second-stand-section 130 made of wood, with other embodiments including stand interface of instrument peg 110 and instrument peg mount 140 made of metal or other materials (e.g., composites, plastics, ceramics, etc.).

Portable stand for a wind musical instrument 100 may be adaptable to support a wide variety of instruments which may include (but not limited to) a clarinet, a piccolo, an English horn, an oboe or others. Adaptations may also be incorporated (e.g., straps, handles, prongs, etc.) into portable stand for a wind instrument such that the stand may accommodate other instruments as needed.

FIG. 5 is a flow diagram illustrating a method of using a portable stand for a wind musical instrument 100, according to an embodiment of the present disclosure. In particular, method of using a portable stand for a wind musical instrument 500 may include one or more components or features of the portable stand for a wind musical instrument 100 as described above. As illustrated, the method for method of using a portable stand for a wind musical instrument 500 may include the steps of: step one 501, providing a portable stand 100; step two 502, opening the portable stand 100 into an open position; step three 503, placing an instrument peg 110 into first-stand-section 120 and/or second-stand-section 130; step four 504, placing at least one musical instrument upon instrument peg 110; step five 505, removing the musical instrument from the instrument peg 110; step six 506, removing the instrument peg 110; and step seven 507, placing instrument peg 110 into first-half-section 120 and/or second-half-section 130.

It should be noted that step five 505, step six 506, and step seven 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for method of using a portable stand for a wind musical instrument.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable stand for a wind musical instrument, the portable stand comprising:
an instrument peg including an instrument interface and a stand interface, said instrument interface configured removably interface with and support the wind musical instrument;
a first-stand-section including an first-inside face, a first-outside-face, and a first-perimeter extending between the first-inside-face and the first-outside-face, said first-inside-face including a first-recess dimensioned and sized to receive a first portion of the instrument peg;
a second-stand-section including a second-inside-face, a second-outside-face, and a second-perimeter extending between the second-inside face and the second-outside-face, said second inside-face including a second-recess dimensioned and sized to receive a complementary portion of the instrument peg, said second-stand-section hingeably coupled to said first-stand-section via at least one hinge; and an instrument peg mount secured to at least one of the first-stand-section and the second-stand-section, said instrument peg mount configured removably receive and support the instrument peg via the stand interface; and
wherein the portable stand includes a deployed state and a secured state,
the deployed state defined by the first-stand-section and the second-stand-section being opened relative to the at least one hinge, by the stand interface of the instrument peg being received and coupled to the instrument peg mount such that the instrument peg is supported in an upright orientation, and by the first-stand-section and the second-stand-section arranged as a base for the instrument peg to support the wind musical instrument in the upright orientation,
the secured state defined by the first-stand-section and the second-stand-section being closed relative to the at least one hinge, by the first-inside face of the first-stand-section mating with the second-inside face of the second-stand-section, and by the first portion and the complementary portion of the instrument peg being received by and embedded in the closed first inside-face of the first-stand-section and the second inside-face of the second-stand-section, respectively.

2. The portable stand of claim 1, further comprising carrying handle configured to support the portable stand while in the secured state and during transport.

3. The portable stand of claim 1, further comprising a security lock configured to maintain the portable stand in the secured state.

4. The portable stand of claim 3, wherein the security lock includes at least two magnets configured to maintain the portable stand in the secured state during transport.

5. The portable stand of claim 3, wherein the security lock includes a clasp configured to maintain the portable stand in the secured state during transport.

6. The portable stand of claim 1, wherein at least portions of the first-inside-face and the first-outside-face include padding configured to provide protection to the instrument peg during transport.

7. The portable stand of claim 1, wherein the at least one hinge includes two hinges.

8. The portable stand of claim 1, wherein the instrument peg mount includes a threaded receiver; and
wherein the stand interface of the instrument peg is configured to screw into the threaded receiver of the instrument peg mount.

9. The portable stand of claim 1, wherein the portable stand is configured to receive, support, and stow a plurality of instrument pegs.

10. The portable stand of claim 9, further comprising:
a second instrument peg including a second instrument interface and a second stand interface, said second instrument interface configured removably interface with and support a second wind musical instrument; and
a second instrument peg mount secured to at least one of the first-stand-section and the second-stand-section, said second instrument peg mount configured removably receive and support the second instrument peg via the second stand interface; and
wherein the first-inside face of the first-stand-section further includes a second-recess dimensioned and sized to receive a second portion of the second instrument peg;
wherein the second-inside-face of the second-stand-section further includes a fourth-recess dimensioned and sized to receive a second complementary portion of the second instrument peg;
wherein the deployed state is further defined by the second stand interface of the second instrument peg being received and coupled to the second instrument peg mount such that the second instrument peg is supported in a second upright orientation, and by the first-stand-section and the second-stand-section being further arranged as the base for the second instrument peg to support the second wind musical instrument in the second upright orientation; and
wherein the secured state is further defined by the second portion and the second complementary portion of the instrument peg being received by and embedded in the closed first inside-face of the first-stand-section and the second inside-face of the second-stand-section, respectively.

11. The portable stand of claim 1, wherein the instrument peg, the first-stand-section, and the second-stand-section are made of wood.

12. The portable stand of claim 1, wherein the stand interface of the instrument peg and the instrument peg mount and are made of metal.

13. The portable stand of claim 1, wherein the musical instrument includes a clarinet.

14. The portable stand of claim 1, wherein the instrument includes a piccolo.

15. The portable stand of claim 1, wherein the musical instrument includes an English horn.

16. The portable stand of claim 1, wherein the musical instrument includes an oboe.

17. A portable stand for a wind musical instrument, the portable stand comprising:
an instrument peg including an instrument interface and a stand interface, said instrument interface configured removably interface with and support the wind musical instrument;
a first-stand-section including an first-inside face, a first-outside-face, and a first-perimeter extending between the first-inside-face and the first-outside-face, said first-inside-face including a first-recess dimensioned and sized to receive a first portion of the instrument peg;
a second-stand-section including a second-inside-face, a second-outside-face, and a second-perimeter extending between the second-inside face and the second-outside-face, said second inside-face including a second-recess dimensioned and sized to receive a complementary portion of the instrument peg, said second-stand-section hingeably coupled to said first-stand-section via at least one hinge; and an instrument peg mount secured to at least one of the first-stand-section and the second-stand-section, said instrument peg mount configured removably receive and support the instrument peg via the stand interface;
a carrying handle configured to support the portable stand while in the secured state and during transport;
a security lock including at least two magnets configured to maintain the portable stand in the secured state.
wherein the portable stand has an deployed state and a secured state, the deployed state,
the deployed state defined by the first-stand-section and the second-stand-section being opened relative to the at least one hinge, by the stand interface of the instrument peg being received and coupled to the instrument peg mount such that the instrument peg is supported in an upright orientation, and by the first-stand-section and the second-stand-section arranged as a base for the instrument peg to support the wind musical instrument in the upright orientation,
the secured state defined by the first-stand-section and the second-stand-section being closed relative to the at least one hinge, by the first-inside face of the first-stand-section mating with the second-inside face of the second-stand-section, and by the first portion and the complementary portion of the instrument peg being received by and embedded in the closed first inside-face of the first-stand-section and the second inside-face of the second-stand-section, respectively.

18. The portable stand of claim 17, further comprising set of instructions; and
wherein the portable stand is arranged as a kit.

19. A method of using a portable stand, the method comprising the steps of:
providing a portable stand;
opening the portable stand into an open position;
placing an instrument peg into the first-stand-section; and
placing at least one musical instrument upon the instrument peg.

20. The method of claim 19, further comprising the steps of:
removing the musical instrument from the instrument peg;
removing the instrument peg; and
placing the instrument peg into first-half-section for transport.
